(19) United States
(12) Patent Application Publication
(10) Pub. No.: US 2005/0138737 A1
(43) Pub. Date: Jun. 30, 2005

(54) Combined pen and knife implement

(76) Inventor: Anton Julian Rudi Klein, Monmouthshire (GB)

Correspondence Address: GORDON & JACOBSON, P.C., 60 LONG RIDGE ROAD, SUITE 407, STAMFORD, CT, 06902, US

(21) Appl. No.: 10/470,175

(22) PCT Filed: Jul. 2, 2003
(86) PCT No.: PCT/GB03/02308

(51) Int. Cl. B26B 11/00

(52) U.S. Cl. 7/160

(57) ABSTRACT

A combined writing instrument and knife comprises a tubular body, a mount disposed within the body, an elongate writing element (e.g., pen or pencil) projecting in one direction from the mount, and a knife projecting in the opposite direction from the mount. The mount is displaceable in one direction to extend the writing element from one end of the body, or in the opposite direction to extend the knife from the opposite end of the body.

The present invention relates to an implement in the form of a combined pen or pencil and knife.

There are various situations where use of both a pen or pencil and a knife are required: typically in such situations use is made of separate implements. A number of combined pen-and-knife implements have been proposed hitherto, but these have been of relatively complicated construction, often incorporating other devices also, and/or have been difficult to use.

We have now devised a combined pen-and-knife or pencil-and-knife implement which is of simple and inexpensive construction and also easy and convenient to use, without risk of the user cutting himself or herself with the knife whilst using the pen or pencil.

In accordance with the present invention, there is provided an implement in the form of a combined pen or pencil and knife, the implement comprising an elongate, tubular body, a mount disposed within said tubular body, a pen or pencil projecting in one direction from said mount and a knife projecting in the opposite direction from said mount, the mount being displaceable in said one direction to extend the tip of said pen or pencil from one end of said body, and in said opposite direction to extend said knife from the opposite end of said body.

In use therefore, either the pen (or pencil) or the knife may be extended for use. When the pen or pencil is extended, the knife is disposed within the tubular body and is therefore safely out of harm's way. Similarly, when the knife is extended, the pen or pencil is disposed within the tubular body. Preferably the mount may be moved to an intermediate position, in which both the pen (or pencil) tip and the knife are disposed within the tubular body.

Preferably an element extends from the mount and through an elongate opening in the side of the tubular body, to enable the user to move the mount longitudinally within the body. Preferably this element includes an elongate clip, extending alongside the tubular body, for retaining the implement in the pocket of a shirt, jacket or other garment.

Preferably means are provided for retaining the mount in each of the positions to which it is moved. For this purpose, preferably the elongate opening in the side of the tubular body is formed with serrations along at least one edge thereof, for engagement by at least one tooth provided on the element extending through this opening. Preferably this element is displaceable inwardly, against a spring bias, to disengage its tooth or teeth from the serrations of the elongate opening, to permit longitudinal displacement of the mount.

An embodiment of the present invention will now be described by way of example only and with reference to the accompanying drawings, in which:

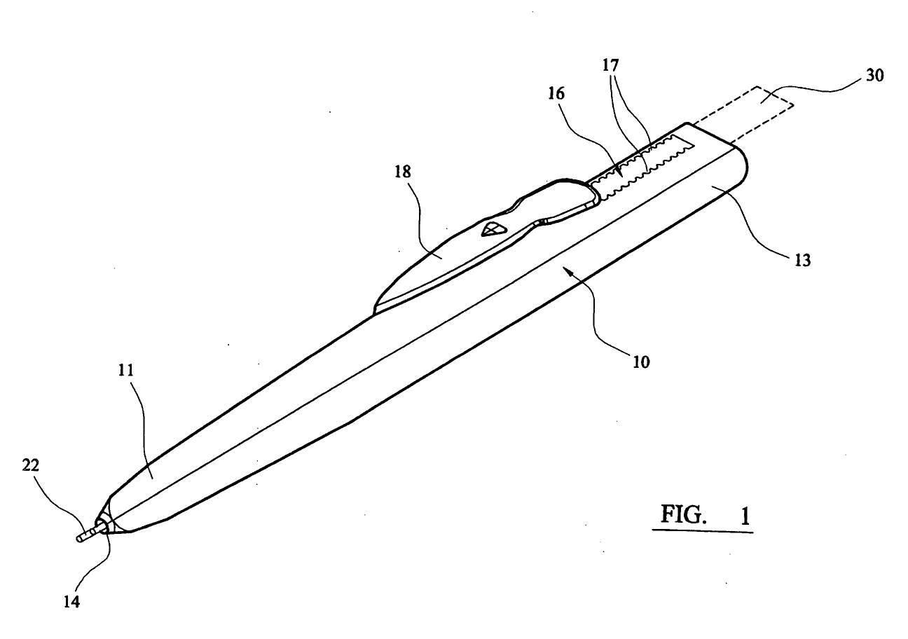

FIG. 1 is an isometric view of a combined pen-and-knife implement in accordance with the invention, the pen tip being shown in full lines in its extended position and the knife blade shown in dotted lines in its extended position;

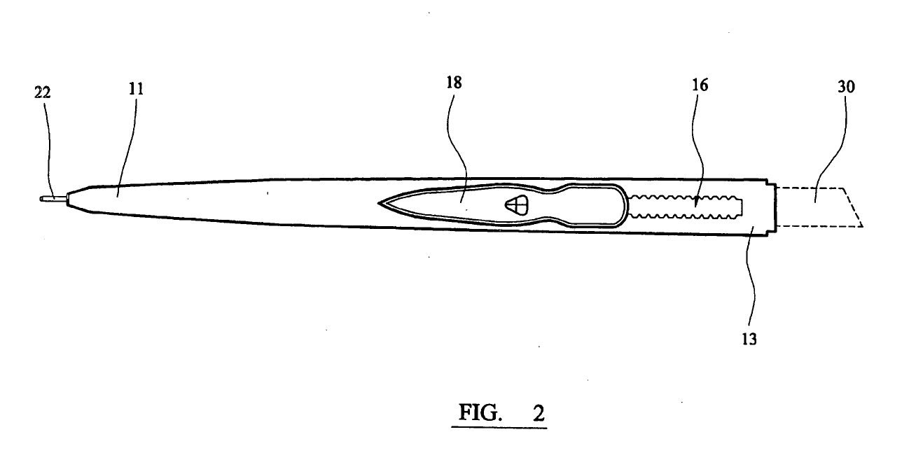

FIG. 2 is a top view of the implement shown in FIG. 1; and

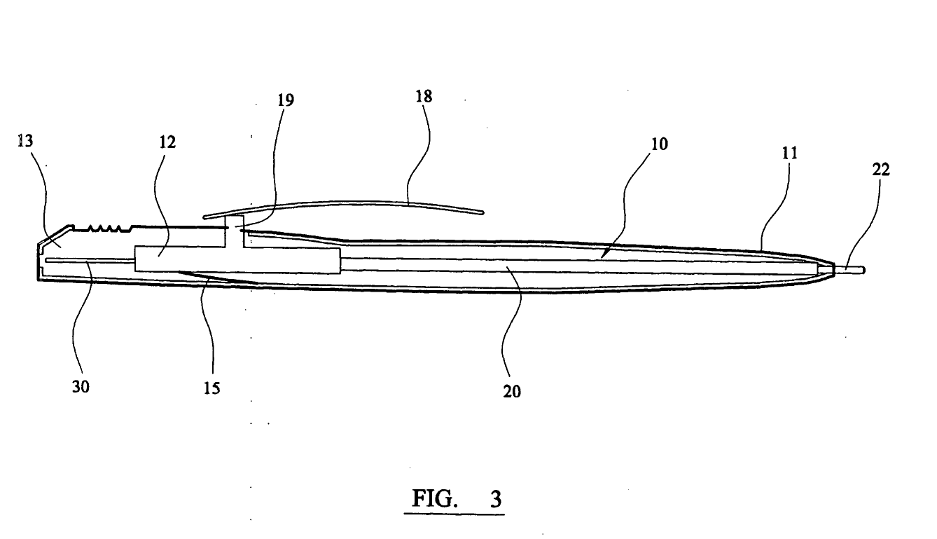

FIG. 3 is a longitudinal sectional view of the implement shown in FIGS. 1 and 2.

Referring to the drawings, there is shown an implement in the form of a combined pen and knife. The implement comprises an elongate, tubular body 10 housing an elongate mount 12 for a ball-point pen 20 and a flat knife blade 30, which project in opposite directions from the mount. The mount 12 is arranged for sliding movement longitudinally within the tubular body 10. The body 10 tapers towards a forward end 11, where it is formed with a small, circular opening 14 for the pen tip 22 to pass through. At its opposite or top end 13, the body 10 is formed with a rectangular opening for the knife blade 30 to pass through.

An elongate opening 16 is formed in the side of the body 10, adjacent its top end 13, the opposite longitudinal edges of this opening being formed with serrations 17. The implement further comprises a clip 18 which extends alongside the body 10, directed towards the forward end 11 of the implement: at its top end, the clip 18 has a support 19 which passes through the opening 16 and is fixed to the sliding mount 12. Opposite sides of the clip support 19 are formed with teeth (not shown) for engaging the serrations 17 of the opening 16.

In use, the clip 18 is used to move the mount 12 either in a forward direction to extend the pen tip 22 out of the forward end 11 of the body 10, or in the opposite direction to extend the knife blade 30 out of the top end of the body 10. Normally the clip 18, and hence the mount 12, are held against movement in either direction, by engagement of the teeth of the clip support 19 with the serrations 17 of the opening 16: in order to release this engagement, the top end of the clip 18 is pressed inwardly to bring a narrower, outer-end section of the clip support into the plane of the opening 16. Once the clip 18 and mount 12 have been moved to the desired position and the inward pressure on the clip is released, then the clip 18 moves outwardly again (to re-engage the teeth on the clip support with the serrations 17 of the opening 16) under the action of a spring finger 15 which is provided on the mount 12 and acts against the opposite inner side of the body 10.

When use of the implement is not required, the clip 18 and mount 12 may be moved to an intermediate position in which the pen tip 22 and knife blade 30 are both disposed within the tubular body 10. The implement may then be carried in a pocket, using the clip 18 to hold it to the pocket: the outward pressure which this now applies to the clip 18 ensures that the teeth on its support 19 will engage with the serrations 17 of the opening 16, and so ensure that both the pen and the knife will remain within the body 10.

Whilst the implement has been described as including a ball-point pen 20, it may instead include a pen of any alternative type, or a pencil.

1) An implement comprising an elongate, tubular body, a mount disposed within said tubular body, an elongate writing element projecting in one direction from said mount and a knife projecting in opposite direction from said mount, the mount being displaceable in said one direction to extend the tip of said elongate writing element from one end of said body, and in said opposite direction to extend said knife from the opposite end of said body.

2) An implement as claimed in claim 1, in which said mount is displaceable to an intermediate position in which both said elongate writing element and said knife are disposed within said tubular body.

3) An implement as claimed in claim 1, further comprising an element extending from said mount through an elongate opening in the side of said tubular body, to enable a user to displace said mount longitudinally within said body.

4) An implement as claimed in claim 3, in which said element includes an elongate clip extending alongside said tubular body.

5) An implement as claimed in claim 1, further comprising means for retaining said mount in said longitudinal position to which it is displaced.

6) An implement as claimed in claim 5, further comprising an element extending from said mount through an elongate opening in the side of said tubular body, to enable a user to displace said mount longitudinally within said body, wherein said elongate opening is formed with serrations along at least one edge thereof, for engagement by at least one tooth provided on said element extending through said opening.

7) An implement as claimed in claim 6, in which said element is displaceable inwardly, against a spring bias, to disengage its said at least one tooth from said serrations.

8) An implement as claimed in claim 1, in which said elongate writing element comprises a pen.

9) An implement as claimed in claim 1, in which said elongate writing element comprises a pencil.
